(19) United States
(12) Patent Application Publication
(10) Pub. No.: US 2025/0377502 A1
(43) Pub. Date: Dec. 11, 2025

(54) OUTCOUPLING DEVICE AND OPTICAL FIBER CONNECTOR HAVING SUCH A DEVICE

(71) Applicant: HUBER+SUHNER Cube Optics AG, Mainz (DE)

(72) Inventors: Dietrich DREWS, Selzen (DE); Manfred HÜBNER, Wiesbaden (DE); Samuel BRANTZEN, Mainz (DE)

(21) Appl. No.: 19/233,461

(22) Filed: Jun. 10, 2025

(30) Foreign Application Priority Data
Jun. 11, 2024 (DE) 10 2024 116 349.6

(51) Int. Cl. G02B 6/32

(52) U.S. Cl. CPC G02B 6/32

(57) ABSTRACT

An outcoupling device for outcoupling an optical signal from a hollow-core optical fiber is provided. The outcoupling device includes: a hollow-core optical fiber having a first end section and a second end section, each including an end face of the optical fiber, and a main section arranged between the first end section and the second end section, the hollow-core optical fiber having a core configured to conduct light signals and a cladding surrounding the core and having a length l, the core within the main section having a constant, non-circular cross-sectional area.

### CROSS-REFERENCE TO RELATED APPLICATION

This application claims priority to German Patent Application No. DE 10 2022 132 512.1 filed Dec. 7, 2022, which is incorporated herein in its entirety.

### TECHNICAL FIELD

The present invention relates to an outcoupling device for outcoupling an optical signal from a hollow-core optical fiber. The outcoupling device captures the light signals emerging from the hollow-core optical fiber and forwards them for further processing to, for example, a further optical fiber, a multiplexer, a demultiplexer, an optical sensor, or a grating coupler.

### BACKGROUND

An outcoupling device can include:
a hollow-core optical fiber having a first end section and a second end section, each comprising an end face of the optical fiber, and a main section arranged between the first end section and the second end section, the hollow-core optical fiber having a core configured to conduct light signals and a cladding surrounding the core, and the hollow-core optical fiber having a length I, the core within the main section having a constant, non-circular cross-sectional area,
a lens with an entrance surface facing the first end section and an exit surface facing away from the second end section,
a holder holding the first end section and the lens, the lens being formed and arranged such that a beam emerging from the first end section impinges on the entrance surface and is projected as a convergent beam onto the exit surface.

Optical fibers are known. In the most common cases, such optical fibers consist internally of a glass core and a surrounding cladding with a slightly lower refractive index, so that total internal reflection at the interface between cladding and glass core guides the radiation. Such fibers nowadays form the heart of high-performance telecommunications networks. However, these full-core fibers have a limited network capacity, so that a capacity bottleneck threatens if the amount of data to be transmitted continues to grow. A capacity improvement in these optical fibers is not to be expected, inter alia, due to the nonlinear Shannon limit.

Therefore, hollow-core fibers or hollow-core optical fibers have been receiving more and more attention for several years. Hollow-core fibers, where light is guided over long distances in air or vacuum, offer advantages compared to the full-core fibers described above. The air-filled core is surrounded by a micro-structured glass cladding that allows a high light concentration.

Particularly in focus are the so-called NANFs (“Nested antiresonant nodeless fibres”), which represent a special type of hollow-core fiber that exhibits particularly low attenuation and high efficiency in light guidance. These NANFs consist of a central hollow-core surrounded by several cylindrical glass tubes nested one inside the other and attached to the inside of a glass tube cladding. Usually five or six such glass tubes are present, while diameter and spacing are set exactly to satisfy an anti-resonant condition in the transverse plane. As a result, the overlap of the light source with the glass is reduced and the light is effectively trapped in the hollow-core, which, due to the structure, is then no longer circular.

While light guidance within the fiber is excellent, coupling the light signals out of the fiber or transferring them into, for example, an adjacent fiber regularly leads to non-negligible losses. Correspondingly designed connectors are used here, but—like any component arranged in the light path—they exhibit an insertion loss. The performance of the entire system is thus limited, when using hollow-core optical fibers, less by the optical fiber itself than by the insertion loss of further required components.

The outcoupling device projects information carried by the beam from the hollow-core fiber onto the exit surface, where it can be further processed or forwarded. For some applications it is preferred if the beam is focused onto the exit surface of the lens. The lens is preferably configured so that the beam diameter at the exit surface is less than 100 μm, more preferably below 25 μm, and most preferably under 10 μm.

Such an outcoupling device in the form of an optical fiber connector is already known from EP 4 220 259 A1, the contents of which are incorporated herein by reference. The detailed construction as well as the arrangement of the lens are described in detail in this document.

The known outcoupling device functions very satisfactorily. Nevertheless, it can be improved.

### SUMMARY

Starting from the described prior art, it is therefore an object of the present invention to provide an outcoupling device whose use reduces the insertion loss into the subsequent element.

According to the invention, this object is achieved in that a first cross-sectional area of the core in the main section differs in size and/or shape from a second cross-sectional area of the core at the end face of the first end section, the second cross-sectional area being larger than the first cross-sectional area and/or the first cross-sectional area having a shape in which a circle having a maximum diameter d₁ₘₐₓ can be inscribed, and the second cross-sectional area having a shape in which a circle having a maximum diameter d₂ₘₐₓ can be inscribed, where d₁ₘₐₓ<d₂ₘₐₓ.

Tests have shown that by changing the cross-sectional area of the core in the end section, the insertion loss of the light signal into the subsequent element can be significantly reduced. Depending on the application, the second cross-sectional area of the core in the first end section must therefore be adjusted accordingly to achieve an optimum result.

The observed effect is particularly pronounced in optical fibers whose core has a non-circular cross-section within the main section. The design with a non-circular cross-section can offer various advantages in light guidance, such as improved mode control, lower polarization dependence, and improved bend insensitivity. Such optical fibers are used, for example, in communication networks that require high bandwidth and low transmission losses.

Preferably, the second cross-sectional area is at least 10% larger than the first cross-sectional area.

Especially in hollow-core fibers, the cross-sectional area of the core has an irregular shape because it is limited only by the glass tubes. However, a central region of the core results that can best be characterized by an inscribed circle touching the glass tubes. In a preferred embodiment, the first cross-sectional area has a shape in which a circle with a maximum diameter d₁ₘₐₓ can be inscribed, and the second cross-sectional area has a shape in which a circle with a maximum diameter d₂ₘₐₓ can be inscribed, where d₁ₘₐₓ<d₂ₘₐₓ. Preferably, d₂ₘₐₓ is at least 10%, and most preferably at least 20%, larger than d₁ₘₐₓ.

Furthermore, it has been shown that it is advantageous if the change in shape does not occur abruptly but gradually in the end section, i.e. that a change in shape of the core already occurs at a certain distance from the end face. Therefore, in a preferred embodiment, the cross-sectional area of the core increases monotonically from the main section toward the end face within the first end section. In a more preferred embodiment, this increase is strictly monotonic. In a monotonically increasing cross-sectional area, intermediate regions are also possible in which the cross-sectional area of the core remains constant, whereas in a strictly monotonically increasing course, the cross-sectional area continually increases.

Furthermore, it is advantageous if, in the first end section, proceeding from the main section toward the end face, the maximum diameter of a circle inscribed in the cross-sectional area increases monotonically, preferably the deformation, i.e. the increase in the diameter of the inscribed circle, increases strictly monotonically.

Furthermore, it is advantageous if the first end section has, in the direction toward the main section, a length l_{E} of at least 30 μm, preferably at least 50 μm, and particularly preferably at least 100 μm. In a preferred embodiment, the length of the end section is less than 1 mm, preferably less than 500 μm, and most preferably between 100 μm and 300 μm.

Even if the shape of the core in the first end section differs from the shape of the core in the main section, it is advantageous if the outer diameter of the cladding in the main section corresponds to the outer diameter of the cladding in the first end section.

In a further preferred embodiment, it is provided that the hollow-core fiber is a photonic crystal fiber or an antiresonant fiber.

Hence, preferably the cladding has a structure that exhibits either a photonic bandgap or an antiresonant property.

In a photonic crystal fiber, light guidance occurs through bandgaps. These fibers have a core surrounded by a regular structure of tiny air channels—as part of the cladding. Bandgaps arise when the periodic pattern of air channels prevents certain wavelengths of light from propagating in certain directions, thereby trapping the light within the core. This allows very precise control over the guided wavelengths.

In an antiresonant fiber, there is a hollow or gas-filled core at the center of the fiber. This core is surrounded by a structure that serves as a cladding. At least part of the structure is made of materials with different refractive indices. They are designed so that they are antiresonant at certain wavelengths.

The core principle behind antiresonant fibers is the use of antiresonant effects to guide light within the hollow-core. The light that strikes the surrounding structure is reflected rather than absorbed or transmitted. This happens because the dimensions of the structure are chosen so that they create destructive interference at certain wavelengths.

As already explained, it is advantageous for the structure to have a plurality of cylindrical tubes, and it is particularly preferred for capillaries having an outer diameter smaller than an inner diameter of the tubes to be arranged in the cylindrical tubes.

In this embodiment, it is advantageous if the tubes, and preferably also the capillaries, are non-circular in the second cross-sectional area and circular in the first cross-sectional area.

The enlargement of the core therefore essentially results from a deformation of the tubes and capillaries.

Furthermore, the insertion loss can be further reduced if the lens and its entrance surface are formed and arranged such that the focal point of the lens is not located on the end face but in the core of the hollow-core fiber, preferably the focal point lying within the main section or at a boundary between the first end section and the main section.

In a further preferred embodiment, it is provided that the lens is designed as a 2-section lens and has at least two sections, namely a first section delimited by the entrance surface and a second section delimited by the exit surface, the refractive index n₁ of the first section differing from the refractive index n₂ of the second section.

For special applications, more than two sections may also be provided. For example, the lens may have three sections differing in their refractive index.

If the lens consists of several parts, these parts can be connected to one another with an adhesive. The thin adhesive layer then does not form a lens section within the meaning of the present invention. In a preferred embodiment, it is therefore provided that each section of the lens has a thickness of at least 0.2 mm and preferably at least 0.3 mm, so that the beam passes through each section of the lens over a path length of at least 0.2 or 0.3 mm.

If a beam emerging from the hollow-core fiber impinges on the exit surface of the lens in a focused manner, a second waveguide that is to receive the signal can be positioned with its end face directly against the exit surface of the lens. The transition between the lens and the second waveguide then results in undesirable back reflections that, among other things, reduce the signal strength.

Therefore, the lens is preferably designed as a 2-section lens with two sections of different refractive indices. In a preferred embodiment, the refractive index n₂ of the second section is smaller than the refractive index n₁ of the first section, preferably the refractive index n₂ being less than 1.5 and particularly preferably 1.5>n₂>1.4. This choice of refractive index has proven effective. The refractive index n₂ can preferably be matched to the refractive index of a full-core fiber used as the second optical waveguide.

For example, the first section can be made of a different material from the second section. It is also advantageous if the refractive index n₁ is constant within the first section and/or the refractive index n₂ is constant within the second section, since in this case the 2-section lens can be manufactured more easily. It has been shown that it is particularly preferred if the second section has a greater length in the propagation direction than the first section in the propagation direction.

In a further preferred embodiment, the 2-section lens is formed in two parts with a first part comprising the first section and a second part comprising the second section. The parts can therefore be manufactured separately and positioned adjacent to one another, wherein it is particularly preferred for the two parts of the 2-section lens to have mutually facing contact surfaces at which the two parts are in contact with one another directly or via an adhesive layer arranged therebetween, so that a beam emerging from the first optical waveguide assigned to the 2-section lens impinges on the entrance surface of the first part and passes through the contact surfaces into the second part. The second part can be, for example, a glass body with parallel or nearly parallel entrance and exit surfaces. It is not necessary for each part to have a curved surface. It is merely essential that the combination of the two parts, i.e. the assembled 2-section lens, generates a convergent beam from the light signal emerging from the end face of the first optical waveguide. In a preferred embodiment, the two parts are bonded together so that a thin adhesive layer forms between the two parts. Alternatively, the two parts can also touch one another directly at their contact surfaces without an adhesive layer.

Finally, the present invention also relates to an optical fiber connector for an optical fiber coupler for optically connecting a hollow-core optical fiber to a further optical fiber. The above-mentioned object is achieved here in that the optical fiber connector comprises the outcoupling device according to the invention described above.

Such an optical fiber coupler makes it possible to connect a hollow-core fiber to a full-core fiber. In this case, among other things, the problem exists that hollow-core fibers have a significantly larger mode field diameter than full-core fibers. By using the described optical fibers, the mode field diameter can become even larger in the end section, which exacerbates the problem. However, the described optical fiber coupler is capable of accommodating even such large differences in mode field diameter.

It is of course also possible with the optical fiber connector to connect the hollow-core fiber to a further hollow-core fiber.

### BRIEF DESCRIPTION OF THE FIGURES

Further advantages, features, and application possibilities of the present invention become apparent from the following description of a preferred embodiment and the associated figures. The figures show:

FIG. 1 a longitudinal section of an optical fiber connector according to the invention with a hollow-core optical fiber,

FIG. 2 an enlarged detail from FIG. 1,

FIG. 3 two cross-sectional views of the hollow-core optical fiber,

FIG. 4 enlarged details of the cross-sectional views of FIG. 3,

FIG. 5 a longitudinal-sectional view of the hollow-core optical fiber, and

FIG. 6 a schematic representation of an outcoupling element according to the invention.

### DETAILED DESCRIPTION OF PARTICULAR EMBODIMENTS

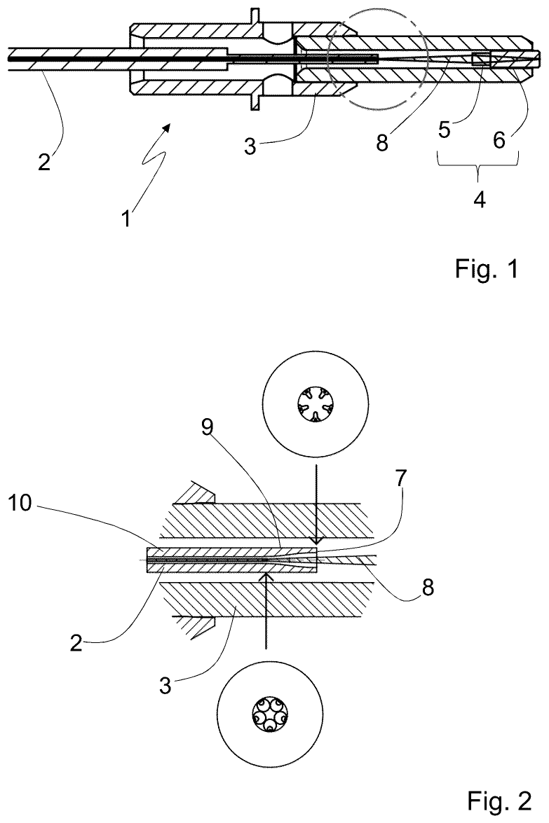

FIG. 1 shows a longitudinal section of an outcoupling device designed as an optical fiber connector according to the invention.

In the optical fiber connector 1, one end of a hollow-core optical fiber 2 is arranged. This end is held in a through-passage of a holder 3. A lens 4 is also provided.

A light beam or beam bundle 8 exits from an end face 7 of the hollow-core optical fiber 2, which widens toward the lens 4. The lens 4 is formed such that it projects the light beam 8, which impinges on an entrance surface of the lens 4, as a convergent beam onto the exit surface of the lens 4 and preferably focuses it. Ideally, the exit surface is located in the focus of the convergent beam. An arrangement outside the focus is also possible, although disadvantageous.

The lens has two sections 5, 6 with different refractive indices.

Although it is described with reference to the preferred embodiment that a light beam 8 exits from the end face 7 of the hollow-core optical fiber 2 and impinges on the entrance surface of the lens 4, the signal path can also be reversed. A signal coupled in through the exit surface of the lens 4 can also be imaged onto the end face 7 of the hollow-core fiber 2.

It can be clearly seen that the lens 4 consists here of two parts, the first part forming the first section 5 and the second part forming the second section 6. The refractive index n1 in the first section 5 is constant and larger than the refractive index n2 in the second section 6. The second section 6 has a length in the propagation direction of the light beam that is significantly greater (in the illustrated example more than twice as long) than the length of the first section 5 in the propagation direction of the light beam.

The first section 5 has the entrance surface and is bonded to the second section 6. The second section 6 has the exit surface. It is clearly visible that the diameter of the second section 6 is larger than the diameter of the first section 5. The diameter of the second section 6 essentially corresponds to the inner diameter of the through-passage of the holder 3. This has the advantage that the lens 4, with the sections 5, 6 already connected to one another, can be inserted into the through-passage of the holder 3 and is then already laterally correctly positioned.

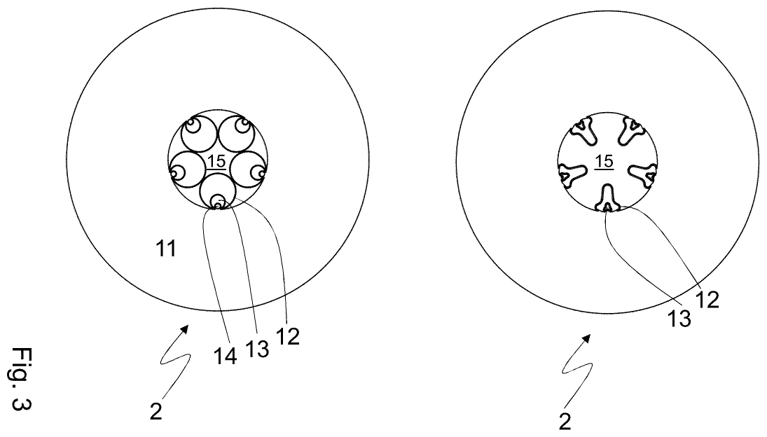

FIG. 2 shows an enlarged detail from FIG. 1. The hollow-core fiber 2, which is held in the holder 3 and has the end face 7, is visible. A beam bundle 8 is again schematically shown. The hollow-core fiber 2 has a core 15 configured to conduct light signals and a cladding surrounding the core 15. The hollow-core fiber 7 has a main section 10, which is bounded by a first end section 9. The hollow-core fiber 7 can be very long, e.g. several kilometers. A second end section is arranged at the end of the main section 10 opposite the first end section 9 and is therefore not shown in the figure.

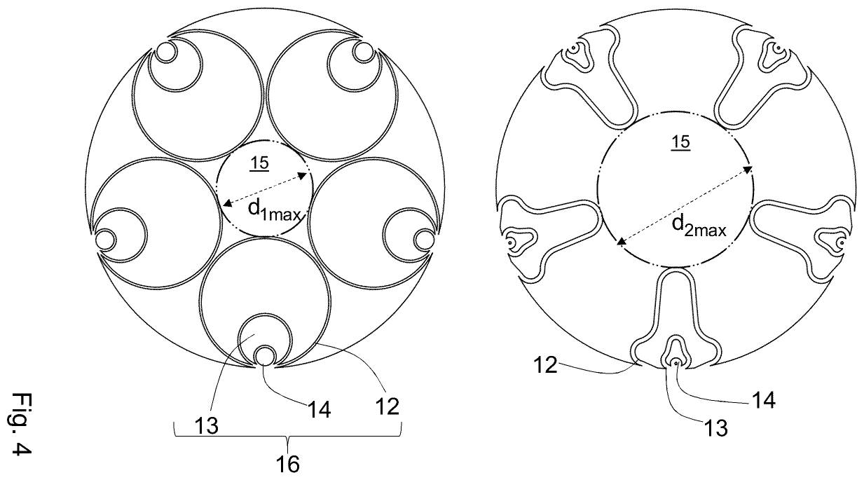

FIG. 2 also shows that the core in the area of the first end section 9 has a larger extent than in the area of the main section 10. FIG. 2 also indicates two cross-sections through the hollow-core fiber 2, which are enlarged in FIG. 3.

In FIG. 3, on the left, a first cross-section of the hollow-core fiber 2 in the main section 10 and, on the right, a second cross-section of the hollow-core fiber 2 in the first end section 9 are shown.

The hollow-core optical fiber has a core 15 configured to conduct light signals and a cladding surrounding the core 15. The cladding in turn consists of a casing 11 and an antiresonant structure 16. The antiresonant structure 16 in turn consists of a plurality of cylindrical tubes 12, in which capillaries 13 are arranged. In the embodiment shown, further capillaries 14 with an even smaller outer diameter are accommodated in the capillaries 13. Light guidance takes place within the core 15, which is non-circular, with the result that the light bundle within the hollow-core optical fiber 2 has a non-circular intensity distribution.

In the right-hand view of FIG. 3, the tubes 12 and capillaries 13 and 14 are greatly deformed, so that the area occupied by the core 15 has become larger.

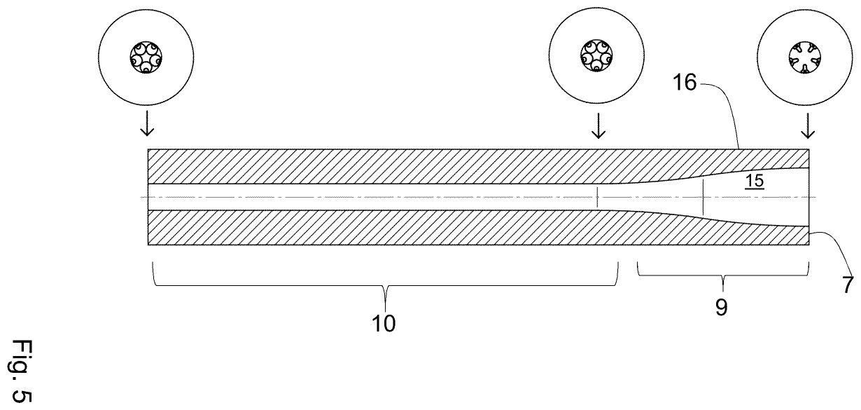

FIG. 4 shows the same views as FIG. 3. The casing 11 has been omitted in order to show the cross-sections in a larger scale. Since the area of the core 15, i.e. the area not occupied by the casing 11 and the antiresonant structure 16, is difficult to determine, a circle with maximum diameter has been inscribed in the region of the core 15 in each case in the figures. The diameter d₁ₘₐₓ of the circle in the left cross-section from the main section 10 is clearly smaller than the diameter d₂ₘₐₓ of the right cross-section from the first end section 9.

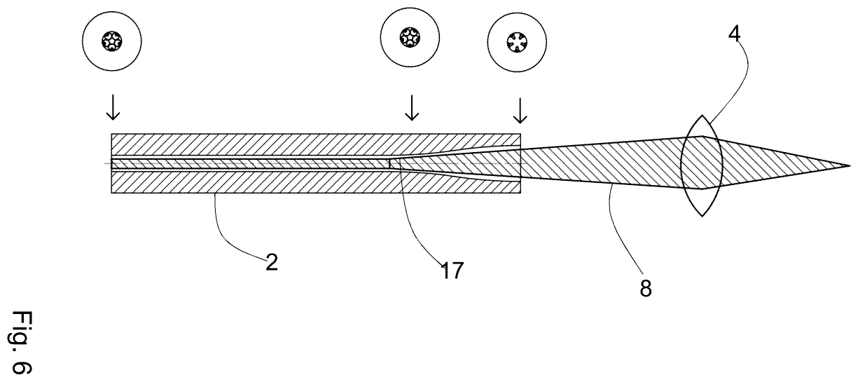

FIG. 5 shows a longitudinal section of a part of the hollow-core fiber 2, which comprises the first end section 9 and a part of the main section 10. The core 15 widens toward the end face 7. In the illustrated embodiment, the cross-sectional area of the core 15 in the end section 9 increases strictly monotonically toward the end face 7.

FIG. 6 schematically shows the structure of an outcoupling device according to the invention. The essential elements of the outcoupling device are the hollow-core fiber 2 with a specially shaped first end section 9 and the lens 4. A light beam 8 guided in the hollow-core fiber 2 is schematically indicated in the illustration. The light beam 8 emerging from the first end section of the hollow-core fiber 2 impinges on the entrance surface of the lens 4 and is projected by the latter as a convergent beam onto the exit surface of the lens 4. The lens 4 is not designed as a 2-section lens in FIG. 6. The lens 4 is formed and arranged such that the focus 17 of the lens 4 lies within the hollow-core fiber 2, in the illustrated example within the main section 10 or in the immediate vicinity of the junction between the main section 10 and the first end section 9.

Due to the described widening of the core 15 in the first end section 9, which faces the lens 4, the light-guiding core 15 becomes more circular, so that, when coupling to a subsequent element, an angular orientation about the optical fiber axis can generally be omitted.

### REFERENCE NUMERAL LIST

1 optical fiber connector
2 hollow-core optical fiber
3 holder
4 lens
5 first section
6 second section
7 end face
8 beam bundle
9 first end section
10 main section
11 casing
12 tube
13, 14 capillary
15 core
16 antiresonant structure
17 focus

1: An outcoupling device for outcoupling an optical signal from a hollow-core optical fiber, the outcoupling device comprising:
a hollow-core optical fiber having a first end section and a second end section, each comprising an end face of the optical fiber, and a main section arranged between the first end section and the second end section, the hollow-core optical fiber having a core configured to conduct light signals, and a cladding surrounding the core, and the hollow-core optical fiber having a length l, the core within the main section having a constant, non-circular cross-sectional area, wherein a first cross-sectional area of the core in the main section differs in size and/or shape from a second cross-sectional area of the core at the end face of the first end section, the second cross-sectional area being larger than the first cross-sectional area and/or the first cross-sectional area having a shape in which a circle having a maximum diameter d₁ₘₐₓ can be inscribed, and the second cross-sectional area having a shape in which a circle having a maximum diameter d₂ₘₐₓ can be inscribed, wherein d₁ₘₐₓ<d₂ₘₐₓ;
a lens with an entrance surface facing the first end section and an exit surface facing away from the second end section, the lens being formed and arranged such that a beam emerging from the first end section impinges on the entrance surface and is projected as a convergent beam onto the exit surface; and
a holder holding the first end section and the lens.

2: The outcoupling device according to claim 1, wherein, in the first end section, proceeding from the main section toward the end face, the size of the cross-sectional area of the core increases monotonically.

3: The outcoupling device according to claim 1, wherein, in the first end section, proceeding from the main section toward the end face, the maximum diameter of a circle inscribed in the cross-sectional area increases.

4: The outcoupling device according to claim 1, wherein the first end section has, in the direction toward the main section, a length l_{E} of at least 30 μm.

5: The outcoupling device according to claim 1, wherein the first end section has, in the direction toward the main section, a length l_{E} of less than 1 mm.

6: The outcoupling device according to claim 1, wherein an outer diameter of the cladding in the main section corresponds to an outer diameter of the cladding in the first end section.

7: The outcoupling device according to claim 1, wherein the hollow-core fiber is a photonic crystal fiber or an antiresonant fiber.

8: The outcoupling device according to claim 7, wherein the cladding has a structure that exhibits either a photonic bandgap or an antiresonant property.

9: The outcoupling device according to claim 8, wherein the structure has a plurality of cylindrical tubes.

10: The outcoupling device according to claim 9, wherein the cylindrical tubes are non-circular in the second cross-sectional area of the core and circular in the first cross-sectional area of the core.

11: The outcoupling device according to claim 1, wherein the lens and its entrance surface are formed and arranged such that the focal point of the lens is not located on the end face but in the core of the hollow-core fiber.

12: The outcoupling device according to claim 1, wherein the lens is designed as a 2-section lens and has at least two sections, namely a first section delimited by the entrance surface and a second section delimited by the exit surface, the refractive index n1 of the first section differing from the refractive index n2 of the second section.

13: An optical fiber connector for an optical fiber coupler for optically connecting a hollow-core optical fiber to a further optical fiber, the optical fiber connector comprising the outcoupling device according to claim 1.

14: The outcoupling device according to claim 2, wherein, in the first end section, proceeding from the main section toward the end face, the size of the cross-sectional area of the core increases strictly monotonically.

15: The outcoupling device according to claim 3, wherein, in the first end section, proceeding from the main section toward the end face, the maximum diameter of a circle inscribed in the cross-sectional area increases monotonically.

16: The outcoupling device according to claim 15, wherein, in the first end section, proceeding from the main section toward the end face, the maximum diameter of a circle inscribed in the cross-sectional area increases strictly monotonically.

17: The outcoupling device according to claim 1, wherein the first end section has, in the direction toward the main section, a length l_{E} between 100 μm and 300 μm.

18: The outcoupling device according to claim 9, wherein capillaries having an outer diameter smaller than an inner diameter of the cylindrical tubes are arranged in the cylindrical tubes.

19: The outcoupling device according to claim 18, wherein the capillaries are non-circular in the second cross-sectional area of the core and circular in the first cross-sectional area of the core.

20: The outcoupling device according to claim 11, wherein the focal point lies within the main section or at a boundary between the first end section and the main section.
